(19) United States
(12) Patent Application Publication
(10) Pub. No.: US 2014/0004020 A1
(43) Pub. Date: Jan. 2, 2014

(54) STAND FOR USE WITH AFFINITY CAPTURE

(71) Applicants: Kemmons A. Tubbs, Mesa, AZ (US); Jesse B. Cohen, San Diego, CA (US)

(72) Inventors: Kemmons A. Tubbs, Mesa, AZ (US); Jesse B. Cohen, San Diego, CA (US)

(73) Assignee: MOLECULAR BIOPRODUCTS, INC., San Diego, CA (US)

(21) Appl. No.: 13/538,300

(22) Filed: Jun. 29, 2012

(51) Int. Cl. B01L 3/02; B01L 9/00

(52) U.S. Cl. 422/509; 422/564

(57) ABSTRACT

An adjustable pipetter stand having a base plate and an arm extending vertically therefrom. The base plate receives a fluid vessel in a workspace defined by the base plate. A vertical guide rail, operatively coupled to the vertically extending arm, receives a guide block that is also operatively coupled to a pipetter. The guide block is configured to support a selected vertical position of the pipetter along the vertical guide rail.

### FIELD OF THE INVENTION

The present invention relates generally to pipetter stands and, more particularly, stands for multi-channel electronic pipetters.

### BACKGROUND

Manual pipetting, while cost efficient for small laboratories and appropriate for small batch processing, may sometimes lead to hand fatigue, pain, numbness, tingling sensations, and/or weakness in the palm and/or thumb. Continued use of manual pipettes may lead to more serious injury such as repetitive strain injury (“RSI”); musculoskeletal disorders, such as injury to muscles, tendons, or ligaments; or carpal tunnel syndrome, which results from compression of the median nerve within the carpal tunnel.

Hand fatigue may be particularly prevalent in certain reagent-intensive assays. For example, Intrinsic Bioprobes, a division of Thermo Fisher Scientific, has recently introduced the MSIA (Mass Spectrometric Immunoassay) pipette tip having a microcolumn comprising a monolithic structure with target specific antibodies coupled thereto and is described in detail in U.S. Pat. No. 6,783,672, issued on Aug. 31, 2004 and entitled INTEGRATED HIGH THROUGHPUT SYSTEM FOR THE MASS SPECTROMETRY OF BIOMOLECULES, the disclosure of which is incorporated herein by reference, in its entirety. Briefly, sample preparation for mass spectroscopy analysis may occur within the pipette tip and without a separate HPLC or other affinity column. However, the MSIA protocol requires repeated aspiration and dispensing of the specimen sample to capture desired proteins followed with repeated aspiration and dispensing of eluent to release the captured proteins. Such protocols, while high effective and cost efficient, may be a burden on the technician using all manual equipment.

Programmable, electronic pipetters have lessened the strain on a manual pipette user. For example, International Application Publication No. WO 2005/079989 entitled ELECTRONIC PIPETTE in the name of Thermo Electron OY, describes one such pipetter that, according to one embodiment, allows direct pipetting and mixing functions, whereby the pipette tip is kept under the liquid surface while several successive aspiration and dispensing movements are performed. Nonetheless, the user must support the electronic pipetter during the direct pipetting and mixing function, which may extend from a few minutes to up to, for example, 40 minutes.

Thus, there remains a need for provide semi-automation, as needed, that enables the manual pipette user to perform successive aspiration and dispensing movements without inducing hand fatigue and/or strain.

### SUMMARY OF THE INVENTION

The present invention overcomes the foregoing problems and other shortcomings, drawbacks, and challenges of known pipette support methods and designs. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention an adjustable pipetter stand having a base plate and an arm extending vertically therefrom. The base plate receives a fluid vessel within a workspace that is defined by the base plate. A vertical guide rail, operatively coupled to the vertically extending arm, receives a guide block that is supports a pipetter. The guide block is configured to support the pipetter in a selected vertical position along the vertical guide rail.

Another embodiment of the present invention is directed to a pipetting system that includes a pipetter stand, a pipetter, and a pipetter mount. The pipetter stand has a base plate and an arm extending vertically therefrom. The base plate receives a fluid vessel within a workspace defined by the base plate. A vertical guide rail that is operatively coupled to the vertically extending arm also receives a guide block that supports the pipetter. The guide block is configured to support the pipetter in a selected vertical position along the vertical guide rail. The pipetter mount is operatively coupled to a portion of the pipetter so as to reversibly couple the pipetter to the guide block.

Still another embodiment of the present invention is directed to a pipetter stand system that includes a base plate and an arm extending vertically therefrom. The base plate receives a fluid vessel. A vertical guide rail that is operatively coupled to the vertically extending arm also receives a guide block that operatively coupled to a pipetter. The guide block is configured to support the pipetter in a selected vertical position of the pipetter along the vertical guide rail. The system further includes a plurality of pipetter mounts, each configured to receive a pipetter having a different number channels and is configured to operatively couple the respective pipetter to the guide block. The guide block supports the pipetter in a selected vertical position along the vertical guide rail.

In accordance with another embodiment of the present invention, a method of performing successive aspirations and dispensing with an automated pipetter includes positioning a fluid vessel, having at least one fluid sample therein, within a workspace defined by a base plate of a pipetter stand. The automated pipetter is operatively coupled to the pipetter stand and slides with respect thereto toward the fluid vessel such that the pipette tip is within the at least one fluid sample. The automated pipetter is activated to successively aspirate and dispense the at least one fluid sample.

The above and other objects and advantages of the present invention shall be made apparent from the accompanying drawings and the descriptions thereof.

### BRIEF DESCRIPTION OF THE FIGURES

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a perspective view of a stand according to one embodiment of the present invention supporting an electronic pipetter and a microtiter plate located on a base plate of the stand.

FIG. 2 is a perspective view similar to FIG. 1 in which the electronic pipetter and a pipetter mount are disassembled from the stand.

FIG. 3 is a side elevational view of the pipetter mount, a receiver, a guide block, and a linear guide rail configured to couple, in a slidable engagement, the electronic pipetter to the stand.

FIG. 4 is side elevational view similar to FIG. 3 with the pipetter mount coupled to the receiver.

FIG. 5 is a perspective view of a stand according to another embodiment of the present invention supporting another electronic pipetter and another microtiter plate located on a base plate of the stand.

### DETAILED DESCRIPTION

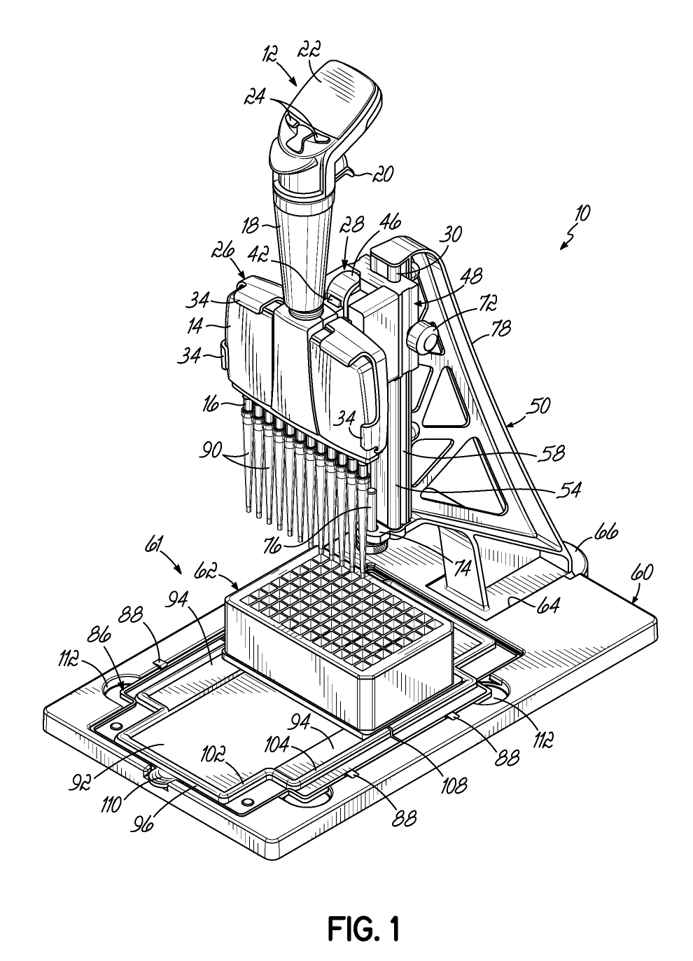

Turning now to the figures, and in particular to FIG. 1, an adjustable stand 10 for use with a pipetter 12 is shown. While any handheld pipetter may be used, the particular pipetter 12 shown herein is a twelve-channel electronic pipetter having a body 14, a distal tip end 16 extending away from the body 14, and a handle 18 extending upwardly away from the body 14. A trigger 20 is operatively coupled to the handle 18 and located so as to be actuated by a user's index finger (not shown). A user interface 22 within user's visual line-of-sight and operatively coupled to a controller (not shown) that is configured to receive inputs from the user, for example, by way of one or more buttons 24, operate a motorized piston (not) for displacing air within the distal tip end 16 while displaying information with respect to operation of the pipetter 12.

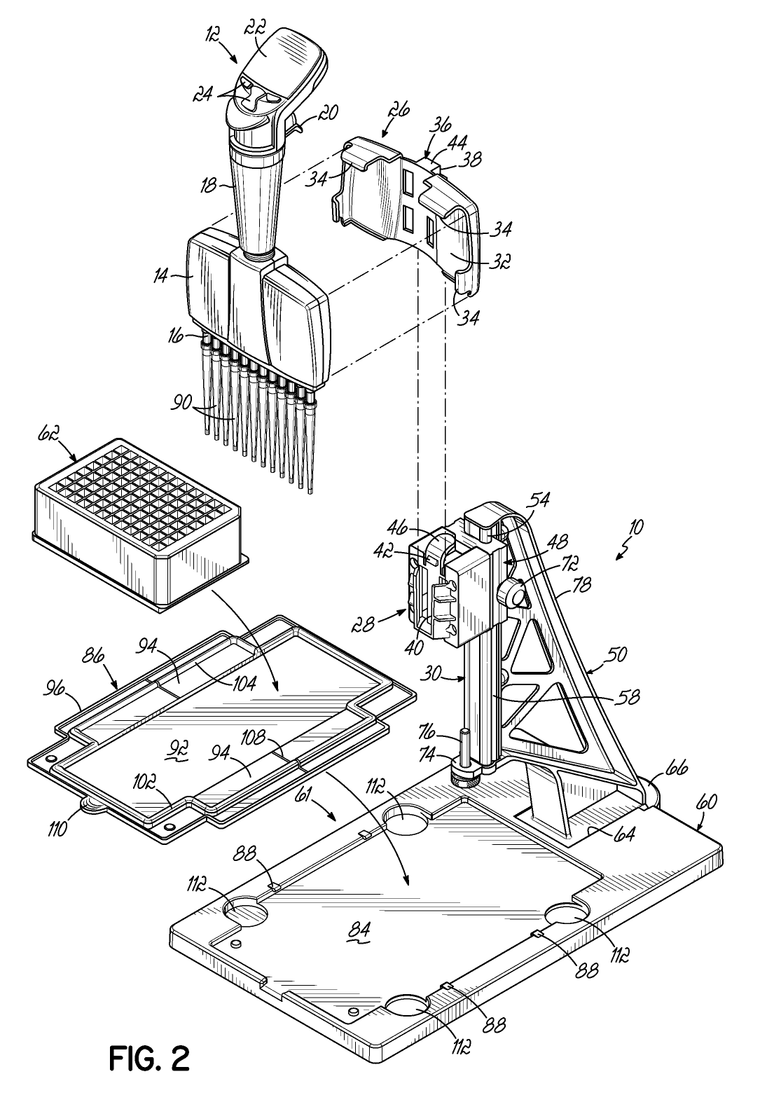

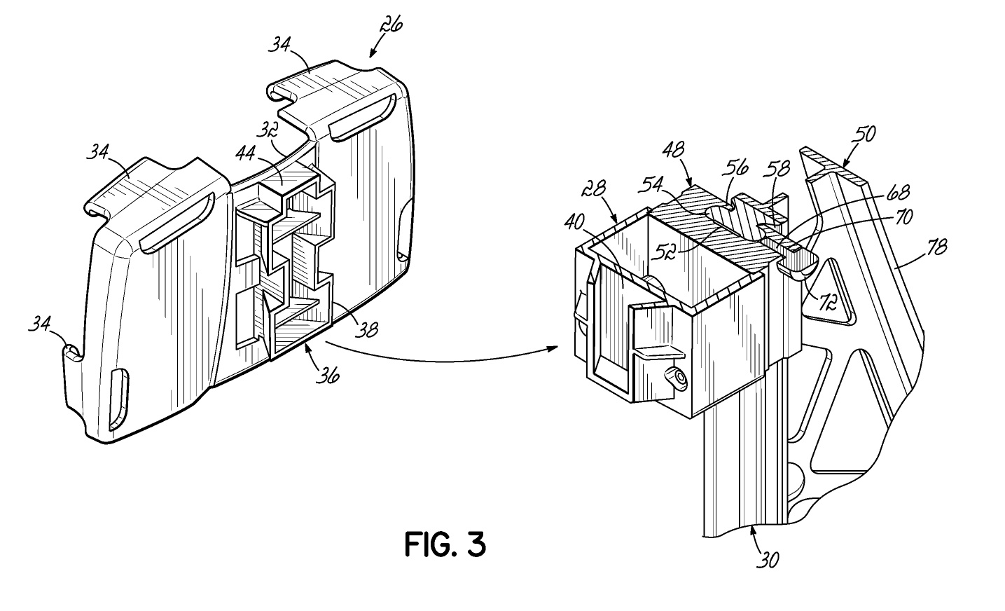

Referring now to FIGS. 2 and 3, a pipetter mount 26, which may be coupled to the pipette body 14, handle 18, or another portion of the pipetter 12 is provided to releaseably couple the pipetter 12 to a receiver 28 that is operatively associated with a linear guide rail 30 of the stand 10. As shown, the linear guide rail 30 extends in the z-axis direction. The pipetter mount 26 may be constructed from a molded polymer and provides a quick release with respect to the receiver 28. For example, and as more particularly shown in FIG. 3, the pipetter mount 26 may include a rear portion 32 that is shaped and sized to conform to the body 14 of the pipetter 12 and a plurality of securement tabs 34 extending from the rear portion 32 so as to grasp the pipetter body 14. The rear portion 32, on a side opposing the securement tabs 34, may include a keyed structure 36, shown herein as a dovetail 38 that is received by a similarly shaped channel 40 of the receiver 28. Accordingly, the dovetail 38, along with the pipetter 12, may slide downwardly into the channel 40 of the receiver 28 until a biased locking tab 42 snaps over a top edge 44 of the dovetail 38, which secures the pipetter 12 to the receiver 28. In removing the pipette 12 from the receiver 28, a release arm 46 operatively coupled to the locking tab 42 and extending upwardly from the channel 40 may be biased so that the locking tab 42 is directed rearwardly and the dovetail 38 may slide upwardly and away from the receiver 28, past the locking tab 42. It would be readily appreciated form the disclosure provided herein that the pipetter mount 26 may therefore remain coupled to the pipetter 12; however, according to other embodiments of the present invention, the pipetter mount 26 may be removed simultaneously or subsequently to removing the pipetter 12 from the stand 10.

The receiver 28 may be constructed from a type of polymer material that may be the same or similar to the material of the pipetter mount 26. Nonetheless, the receiver 28 may be operatively coupled to, or form a unitary structure with, a guide block 48 that slidably engages the linear guide rail 30 supported by a support arm 50 of the stand 10, as shown in FIGS. 1 and 2. As is generally known to those of ordinary skill in the art, the guide block 48 includes a recess 52 configured to receive a head 54 of the linear guide rail 30 while inwardly-directed arms 56 surrounding the recess 52 are configured to be proximate to and slide along a web 58 of the linear guide rail 30.

The support arm 50 is, in turn, coupled to a base plate 60 defining an x-y plane that is generally orthogonal to the z-axis aligned linear guide rail 30. The base plate 60 provides a horizontal stable base for the stand 10 and is configured to receive a fluid vessel, for example, a 12×8 microtiter plate 62, in a workspace 61 defined by the base plate 60, for use in a manner generally described below. While the support arm 50 and the base plate 60 may be molded as a single unit, in the illustrative embodiment of the present invention, the components are molded as separate units such that the support arm 50 may slide into a slot 64 provided in the base plate 60. The sliding engagement between the support arm 50 and the base plate 60 may be permanent or configured to be reversible such as when stowing the stand 10. When the support arm 50 is rreversibly mounted of the base plate 60, the base plate 60 may include a biased locking tab 66 configured to retain the support arm within the slot 64.

The support arm 50 supports the linear guide rail 30 in the z-direction such that the guide block 48, with the receiver 28 and/or the pipetter mount 26 with or without the pipetter 12, may slide onto and along the linear guide rail 30. When a desired position of the guide block 48 relative to the linear guide rail 30 is selected positioning mechanism, such as a stud 68, extending through a side bore 70 of the guide block 48, may extend into the web 58 of the linear guide rail 30 and create a frictional interference that is sufficient to resist further vertical movement of the guide block 30. A knob 72, lever, or other manipulation device allows the user to reversibly secure the stud 68 relative to the web 58 of the linear guide rail 30. Although not shown herein, one of ordinary skill in the art will appreciate that other mechanisms for securing the position of the guide block 48 relative to the linear guide rail 30 may include, for example, a rack and pinion or other suitable mechanical devices.

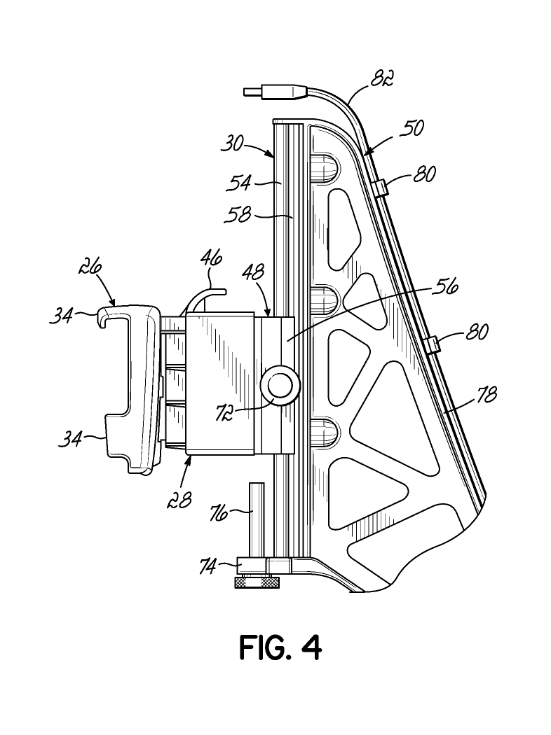

As shown in FIG. 4, the support arm 50 may further include a dead stop 74, spaced away from the base plate 60 and configured to prevent downwardly-directed sliding of the guide block 48 from the desired position and relative to the linear guide rail 30. If desired, minor adjustments to the stop height for the guide block 48 relative to the linear guide rail 30 may be accomplished via a thumb screw 76 that extends upwardly through the dead stop 74. As illustrated herein, the thumb screw 76 permits up to about 1 inch adjustment in the dead stop height; however, other tolerances may also be used.

In those embodiments of the present invention wherein an electronic pipette 12 is used, a spine 78 of the vertically extending support arm 50 may include one or more fasteners 80, such as tabs, to retain an electrical power cord 82 operatively coupled to the pipetter 12 adjacent to the support arm 50. In this way, the pipetter 12 may be charged via the electrical power cord 82 while in reducing interference between the electrical power cord 82 and use on the stand 10.

Turning now to FIGS. 1 and 2, details of the base plate 60 are shown and described in greater detail. The base plate 60 includes a recessed surface 84 that is configured to receive a removable tray 86, which in turn is configured to receive the microtiter plate 62 or other fluid vessel. The base plate 60 may be constructed from a moldable polymeric material, such as polypropylene, that is resistant to laboratory liquids, such as organic solvents. The recessed surface 84 may include undercut tab portions 88 so as to retain the removable tray 86 within the recessed surface 84 and in a flat orientation.

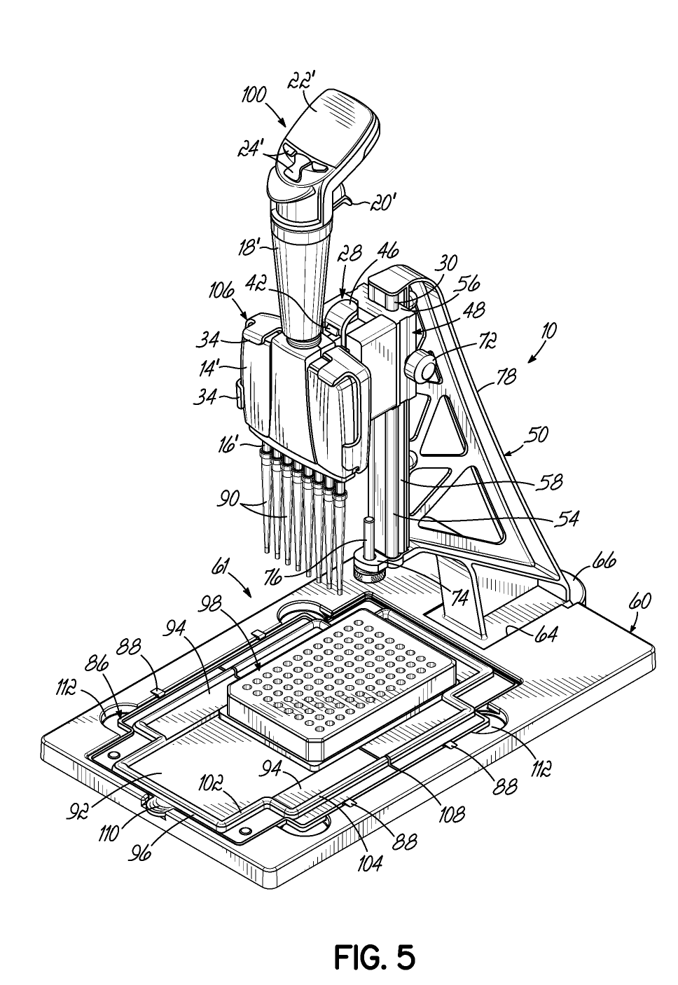

The removable tray 86 may be shaped such that the microtiter plate 62 may slide in a direction that is generally parallel to the y-axis so as to advance or index rows of wells with respect to pipette tips 90 of the pipetter 12. As shown in FIGS. 1 and 5, the tray 86 may be configured to support microtiter plates of various shapes and sizes. According to one exemplary embodiment of the present invention, the removable tray 86 may be essentially “t”-shaped with an elongated mid-section 92, opposing side wings 94 extending in the +x and −x directions, and a rail 96 about the outer perimeter thereof. While the mid-section 92 may be configured to receive microtiter plates of smaller width (for example, the 8×12 microtiter plate 98 in use with an eight-channel pipetter 100 of FIG. 5, the wider 12×8 microtiter plate 62 is received between the wings 94 as was shown in FIG. 1. In that regard, the wings 94 may be stepped with respect to the elongated mid-section 92 so that separate narrow and wide channels 102, 104 are provided for sliding the respectively sized microtiter plate 62, 98. It would be readily appreciated that the channels 102, 104 may be constructed in accordance with specifications laid out by the Society for Biomolecular Standards (“SBS”) so that the tray 86 may readily accommodate trays by various manufacturers but in accord with the SBS specifications.

It will further be appreciated from the teachings herein that when the eight-channel pipetter 100 is to be mounted to the stand 10, a pipetter mount 106 in accordance with another embodiment of the present invention may be used. The pipetter mount 106, as shown with the pipetter 98 in FIG. 5, is particularly dimensioned to accommodate the smaller body 14′ of the pipetter 98. However, and as alluded to above, other mechanisms of mounting the pipetter to the stand may be configured to attach to the handle 18, 18′ of the pipetter 12, 100, which may accommodate pipetters having any number of channels.

The tray 86 may further include an alignment indicia 108, extending in the x-axis direction and configured to aid in the alignment of a selected row of wells with the pipette tips 90. Alternatively, although not specifically shown herein, the removable tray 86 may further include tactile indicators, such as small indentations, divots, or the like, that provides a slight resistance to the sliding microtiter plate 62, 98. Still other alignment indicators known within the art may be used.

The removable tray 86 may further include a forwardly extending tab 110 provided as a point of contact for the user while inserting or withdrawing the tray 86 from the undercut tabs 88. Additionally, the base plate 60 may include one or more openings 112 located proximate the tray 86 and extending through the base plate 60 that allow the user to slide at least one finger under the removable tray 86 in order to aid in removing the same.

In use, and with reference again to FIG. 1, the user may place the appropriate sample preparation into the microtiter plate 62 or other multi-well vessel and position the microtiter plate 62 on the removable tray 86. The distal tip ends 16 of the pipetter 12 receives pipette tips 90 and, if necessary, the pipetter 12 may be used to aspirate a volume of fluid into the pipette tip 90 for use with the prepared sample. The pipetter 12, with the pipetter mount 26 previously coupled thereto, is coupled to the stand 10 via receipt of the dovetail 38 of the pipetter mount 26 by the channel 40 of the receiver 28. The guide block 48, with the receiver 28, the pipetter mount 26, and the pipetter 12, slides downwardly along the linear guide rail 30 such that the pipette tips 90 enter the selected row of wells of the microtiter plate 62. When the desired tip location is achieved within the wells, for example, when the distal ends of the pipette tips 90 are proximate the bottoms of the wells, the knob 72 on the guide block 48 may be rotated such that the stud 68 engages the web 58 of the linear guide rail 30 and at least temporarily maintains the position of the pipetter 12. If the receiver 28 is not in contact with the dead stop 74, the thumb screw 76 may be advanced until it contacts the receiver 28.

The pipetter 12 may then be set, for example, to a program mode such as direct pipetting and mixing mode, whereby for an allotted period of time, such at about 15 minutes, the pipetter 12 will be automatically and successively aspirate and dispense the prepared sample within the wells of the microtiter plate 62.

Once the program has been completed, the stud 68 is disengaged from the web 58 so that the guide block 48 is lifted upwardly away from the microtiter tray 62. The microtiter tray 62 may be advanced to the next row of wells, removed with the tray 86 to be replaced later or by another tray, or removed without the tray 86 to be replaced with another multi-well plate or a fluid vessel.

While the present invention has been illustrated by description of various embodiments, and while those embodiments have been described in some detail, they are not intended to restrict or in any way limit the scope of the disclosed invention. Additional advantages and modifications will readily appear to those skilled in the art. The various features of the present invention may be used alone or in any combination depending on the needs and preferences of the user. This has been a description of the present invention, along with methods of practicing the present invention as currently known.

What is claimed is:

1. An adjustable pipetter stand, comprising:
a base plate configured to receive a fluid vessel in a workspace defined by the base plate;
a vertically extending arm operatively coupled to the base plate;
a vertical guide rail operatively coupled to the vertically extending arm; and
a guide block configured to support a pipetter and to slidably couple to the vertical guide rail,
wherein the guide block is further configured to support the pipetter in a selected vertical position of the pipetter along the vertical guide rail.

2. The adjustable pipetter stand of claim 1, wherein the fluid vessel is a microtiter plate and the base plate is configured such that the microtiter plate may be indexed in at least one direction relative thereto.

3. The adjustable pipetter stand of claim 1, wherein the guide block includes a positioning mechanism configured to engage the vertical guide rail so as to retain the selected vertical position of the pipetter.

4. The adjustable pipetter stand of claim 3, wherein the positioning mechanism comprises a stud threadably extending through the guide block and engaging the vertical guide rail.

5. The adjustable pipetter stand of claim 1, wherein the guide block further comprises:
a receiver configured to receive a pipetter mount that is configured to be coupled to a portion of the pipetter.

6. The adjustable pipetter stand of claim 5, wherein the pipetter mount includes a dovetail that is configured to be received in a channel of the receiver.

7. The adjustable pipetter stand of claim 5, wherein the pipetter mount is molded to conform to a body of the pipetter.

8. The adjustable pipetter stand of claim 1, wherein the base plate further comprises a tray removably coupled thereto, the tray having a first set of rails such that a first fluid vessel having a first width slides within the first set of rails and a second set of rails such that a second fluid vessel having a second width slides within the second set of rails, the second width being greater than a first width.

9. The adjustable pipetter stand of claim 1, further comprising:
an adjustable stop operatively coupled to the vertical guide rail and configured to define a lowest position of the guide block relative to the vertical guide rail.

10. An automated pipetting system comprising:
a pipetter stand, comprising:
a base plate configured to receive a fluid vessel in a workspace defined by the base plate;
a vertically extending arm operatively coupled to the base plate;
a vertical guide rail operatively coupled to the vertically extending arm; and
a guide block operatively coupled to the pipetter and slidably coupled to the vertical guide rail
a pipetter; and
a pipetter mount operatively coupled to a portion of the pipetter and configured to releaseably couple the pipetter to the guide block.

11. The adjustable pipetter stand of claim 10, wherein the fluid vessel is a microtiter plate and the base plate is configured such that the microtiter plate may be indexed in at least one direction relative thereto.

12. The adjustable pipetter stand of claim 10, wherein the guide block includes a positioning mechanism configured to engage the vertical guide rail so as to retain the selected vertical position of the pipetter.

13. The adjustable pipetter stand of claim 12, wherein the positioning mechanism comprises a stud threadably extending through the guide block and engaging the vertical guide rail.

14. The adjustable pipetter stand of claim 10, wherein the guide block further comprises:
a receiver configured to receive a pipetter mount that is configured to be coupled to a portion of the pipetter.

15. The adjustable pipetter stand of claim 14, wherein the pipetter mount includes a dovetail configured to be received in a channel of the receiver.

16. The adjustable pipetter stand of claim 14, wherein the pipetter mount is molded to conform to a body of the pipetter.

17. The adjustable pipetter stand of claim 10, wherein the base plate further comprises a tray removably coupled thereto, the tray having a first set of rails such that a first fluid vessel having a first width slides within the first set of rails and a second set of rails such that a second fluid vessel having a second width slides within the second set of rails, the second width being greater than a first width.

18. The adjustable pipetter stand of claim 10, further comprising:
an adjustable stop operatively coupled to the vertical guide rail and configured to defines a lowest position of the guide block relative to the vertical guide rail.

19. A pipetter stand system, comprising:
a base plate defining a workspace;
a vertically extending arm operatively coupled to the base plate;
a vertical guide rail operatively coupled to the vertically extending arm;
a guide block slidably coupled to the vertical guide rail; and
a plurality of pipetter mounts, each of the plurality of pipetter mounts being configured to receive a pipetter having a different number of channels and to operatively couple the respective pipetter to the guide block;
wherein the guide block is further configured to support the pipetter in a selected vertical position along the vertical guide rail.

20. The adjustable pipetter stand of claim 19, wherein the guide block includes a positioning mechanism configured to engage the vertical guide rail so as to retain the selected vertical position of the pipetter.

21. The adjustable pipetter stand of claim 20, wherein the positioning mechanism comprises a stud threadably extending through the guide block and engaging the vertical guide rail.

22. The adjustable pipetter stand of claim 19, wherein the guide block further comprises:
a receiver configured to receive a pipetter mount that is configured to be coupled to a portion of the pipetter.

23. The adjustable pipetter stand of claim 22, wherein the pipetter mount includes a dovetail configured to be received in a channel of the receiver.

24. The adjustable pipetter stand of claim 19, wherein the base plate further comprises a tray removably coupled thereto, the tray having a first set of rails such that a first fluid vessel having a first width slides within the first set of rails and a second set of rails such that a second fluid vessel having a second width slides within the second set of rails, the second width being greater than a first width.

25. The adjustable pipetter stand of claim 19, further comprising:
an adjustable stop operatively coupled to the vertical guide rail and configured to define a lowest position of the guide block relative to the vertical guide rail.

26. A method of performing successive aspirations and dispensings with an automated pipetter, the method comprising:
positioning a fluid vessel in a workspace defined by a base plate of a pipetter stand, the fluid vessel having at least one fluid sample therein;
operatively coupling the automated pipetter to the pipetter stand;
sliding the automated pipetter with respect to the pipetter stand and toward the fluid vessel such that a pipette tip of the automated pipetter is positioned within the at least one fluid sample within the fluid vessel; and
activating the automated pipetter such that the at least one fluid sample is successively aspirated and dispensed.

27. The method of claim 26, wherein the fluid vessel is positioned on a removable tray on the base plate of the pipetter stand.

28. The method of claim 26, wherein the successive aspiration and dispensing of the at least one fluid sample continues for a number times or a designated period of time.

29. The method of claim 26, further comprising:
securing the position of the automated pipetter relative to the pipetter stand.

30. The method of claim 26, further comprising:
after the successive aspiration and dispensing, withdrawing the pipette tip from the at least one fluid sample;
indexing the fluid vessel relative to the base plate to another fluid sample;
sliding the automated pipetter relative to the pipetter stand and toward the fluid vessel such that a pipette tip of the automated pipetter is positioned within the at least one fluid sample within the fluid vessel; and
activating the automated pipetter such that the at least one fluid sample is successively aspirated and dispensed.
